(19) United States
(12) Patent Application Publication
(10) Pub. No.: US 2008/0010852 A1
(43) Pub. Date: Jan. 17, 2008

(54) Guiding Device For A Continuous Sheet

(76) Inventors: Markus Oechsle, Bartholomae (DE); Roland Mayer, Heidenheim (DE); Peter Kahl, Gerstetten (DE); Martin Kustermann, Heidenheim (DE); Stefan Reich, Heidenheim (DE)

Correspondence Address: TAYLOR & AUST, P.C., P.O. Box 560, 142. S Main Street, Avilla, IN, 46710, US

(21) Appl. No.: 10/557,369

(22) PCT Filed: May 7, 2004
(86) PCT No.: PCT/EP04/50734

§ 371 Date: Jan. 29, 2007

(30) Foreign Application Priority Data
May 19, 2003 (DE) 10322519.6

(51) Int. Cl. B65H 23/32; F26B 13/08

(52) U.S. Cl. 34/117; 226/20; 242/615.12

(57) ABSTRACT

The invention relates to a guiding device for a continuous paper sheet comprising at least one guiding element which is disposed downstream with respect to an application group and used in the form of an air circulating channel in order to ensure a contactless guiding in a machine producing and/or processing a continuous material sheet, in particular a paper or paperboard sheet. Said guiding element consists of a guiding surface made at least partially of an air-permeable porous material which is exposed to a compressed air pressure in such a way that air can circulate therethrough, thereby forming an air cushion between said guiding surface and a moving material sheet.

### CROSS-REFERENCE TO RELATED APPLICATIONS

The present application claims priority under 35 U.S.C. §119 of German Patent Application No. 103 22 519.6 filed on 19 May, 2003, and International Application PCT/EP2004/050734, filed 7 May 2004, the disclosures of which are expressly incorporated by reference herein in its entirety.

### BACKGROUND OF INVENTION

1. Field of the Invention

The invention relates to a web guide device having at least one guide element arranged after an applicator unit and serving as an air turn for non-contact web guidance in a machine used for the production and/or treatment of a material web, in particular a paper or board web. It relates further to a machine for the production and/or treatment of a material web, in particular a paper or board web, having at least one such web guide device.

2. Discussion of Background Information

Hitherto, the material web has been guided over a conventional air turn. Therefore, although non-contact guidance with a stationary guide element is possible, a non-uniform pressure usually prevails in the air pad. In the event of holes or partial breaks, the web can therefore nevertheless contact the guide element. In addition, no reliable, flat and crease-free web guidance is ensured. For example, what are known as omega creases can in particular occur. Appropriate web guidance is in turn relatively expensive. Large quantities of air and large dimensions are necessary.

An air turn, as it is known, normally has slot nozzles with a mutual slot nozzle spacing of about 20 to about 200 mm and a respective slot width which is greater than 1 mm. If rows of hole nozzles are provided, then the hole nozzle diameter is generally larger than 2 mm. The web spacing from the surface is normally greater than 5 mm, normally lying in a range from 7 to 20 mm. The supply pressure in the air turn is normally in a range from 1 to 6 kPa (=0.06 bar). The specific volume flow is normally in the range from 1000 to 30 000 Nm³/h·m².

### SUMMARY OF THE INVENTION

The invention is based on the object of providing an improved web guide device of the type mentioned at the beginning in which the aforementioned disadvantages are eliminated. Here, in particular, stable, crease-free and reliable, non-contact web guidance is to be achieved. The intention in particular is for use in paper machines, coating machines, calenders, slitter rewinders and so on.

According to the invention, the object is achieved in that the guide element has a guide surface which, at least to some extent, consists of air-permeable porous material to which compressed air can be applied, in order to form an air pad between the guide surface and the moving material web via the air flowing through this porous material.

The high pressure loss and the porous material produce a very uniform air pad, so that the material web is guided reliably at a relatively small distance from the surface. This provides, in particular, a crease-free run. The relatively high internal pressure prevents any web contact with the surface.

The web guide device can therefore in particular comprise at least one guide element which is supplied with compressed air and has an open surface but with a high pressure loss, through which the air is forced from the inside. Therefore, both in time and in space, a stable, uniform air pad is produced which guides the web without contact with the guide element.

The guide element preferably comprises at least one pressure chamber, via which the porous material can have compressed air applied to it. In this case, the porous material can be applied, at least to some extent, to a carrier containing the pressure chamber and provided with air passage openings. However, for example in particular, those embodiments in which the porous material forms at least part of the pressure chamber wall are conceivable.

The pressure in the pressure chamber can in particular be higher than 0.5 bar, preferably being higher than 1 bar.

The specific volume flow in the porous material expediently lies in a range from about 10 to about 5000 Nm³/h·m².

The hole or pore spacing or the spacing of the outlet openings of the air-permeable porous material is preferably less than 1 mm.

The porous material is in particular composed in such a way that no individual jets but, instead, a very uniform air pad is produced, which ensures very good web guidance which, in particular remains contact-free in any case even in the event of holes, cracks or thin strips. In a preferred practical embodiment of the web guide device according to the invention, the average size of the outlet openings, pores and/or holes in the porous material is less than 0.2 mm and preferably less than 0.1 mm.

The porous material is preferably chosen in such a way that a high pressure loss from the interior to the surroundings results, which produces a very uniform air pad. In an expedient practical embodiment of the web guide device according to the invention, the pressure loss, in particular from the side facing away from the moving material web to the side of the porous material facing the material web is greater than 0.2 bar and preferably greater than 0.8 bar.

The thickness of the air pad formed between the guide surface and the moving material web, and therefore the web spacing from the surface, is expediently less than 5 mm and preferably less than 3 mm.

The guide element can in particular be designed as a roll. In this case, this can be designed as a stationary or nonrotating roll or as a rotating, preferably driven, roll.

In particular in the case in which the guide element is designed as a stationary or nonrotating roll, the air pad is advantageously produced on only part of the circumference of the roll.

The roll can have, for example, a diameter in a range from about 50 mm to about 1500 mm.

In an expedient practical embodiment, the guide element is wrapped around only by the material web. In principle, however, such embodiments are also conceivable in which the guide element is also wrapped around by at least one moving belt, in particular a fabric belt, in addition to the material web. In the latter case, the moving belt, in particular fabric belt, can be guided between the guide element and the material web or on the side of the material web facing away from the guide element, that is to say can lie on the outside.

The material web and/or the moving belt can wrap around the guide element for example in accordance with a wrap angle whose range is from about 5 to about 260°.

It is also advantageous in particular if the guide element is designed as a segment of a curve. In this case, it can have a radius of curvature which is constant in the machine running direction or a radius of curvature which changes in the machine running direction. In the latter case, the guide element can have a radius of curvature which changes continuously in the machine running direction or a radius of curvature which changes in discrete steps in the machine running direction.

In order to generate a spreading effect, the guide element or its guide surface can also in particular have a course which is curved in the transverse direction. In this case, the radius of curvature of the guide element or the guide surface can change over the width extending in the transverse direction.

If the guide element is designed as a segment of a curve, then it expediently has a segment height in a range from about 30 to about 500 mm.

The radius of curvature of the guide surface expediently lies in a range from about 5 to about 3000 mm.

In a preferred embodiment of the web guide device according to the invention, the guide element is assembled from a plurality of individual segments in the transverse direction and/or in the machine running direction.

In this case, at least some of the segments can be assigned a common compressed air supply. However, the segments can also, at least to some extent, be supplied via separate compressed air supplies.

In a preferred embodiment of the web guide device according to the invention, an application of compressed air which is separated zone by zone via individual separate segments and/or segment groups in the machine running direction and/or in the transverse direction is provided. In the machine running direction and/or the transverse direction, therefore, specific zone by zone pressure graduation can be carried out.

In another advantageous embodiment of the web guide device according to the invention, the guide surface of the guide element is formed by at least two layers in each case consisting at least to some extent of air-permeable porous material with preferably different properties.

In this case, for example, the pressure loss in the inner layer, facing away from the material web, can be lower than on the outer layer. Alternatively or additionally, the porosity of the inner layer, facing away from the material web, can be higher or its hole spacing can be greater than in the outer layer. Alternatively or additionally, the hole diameter of the inner layer, facing away from the material web, can be greater then in the outer layer. It is also advantageous in particular if the layers consist, at least to some extent, of different material.

A further preferred embodiment of the web guide device according to the invention is distinguished by the fact that the inner layer, facing away from the material web, consists of an air-permeable porous material or is provided with air passage openings only in a subregion and is otherwise air-impermeable, so that an air pad is produced only in a subregion of the guide element.

The inner layer, facing away from the material web, can, at least to some extent, consist in particular of metal, GRP and/or CRP.

The inner layer, facing away from the material web, preferably supplies the mechanical loadbearing capacity of the guide element or of the guide surface.

The outermost surface of the guide element, facing the material web, can in particular consist of finely porous material. It can therefore in particular have a finer level of porosity than the inner layer.

It is also advantageous in particular if the outermost surface of the guide element, facing the material web, is sintered.

However, this outermost surface of the guide element, facing the material web, can, for example, also consist of ceramic material.

It is also advantageous in particular if the outermost surface of the guide element, facing the material web, is easy to clean, therefore for example consists of a material which can be cleaned easily.

The guide surface of the guide element is advantageously provided with air outlet openings preferably produced directly during the production of the outermost surface. The air outlet openings in question therefore do not have to be introduced into the outermost surface by means of subsequent machining.

As already mentioned, the web guide device according to the invention can be used in particular in a machine for the production and/or treatment of a material web, in particular a paper or board web.

At least one appropriate web guide device is preferably provided after, in particular immediately after an applicator unit, used for example for surface treatment, as a replacement for an air turn. As a result of the small web spacing and the uniform air pad, crease-free guidance is also ensured here. Further advantages result from the lower quantity of air and the smaller overall volume.

The guide element can, for example, be wrapped around only by the material web or, for example, also by at least one fabric belt in addition to the material web.

In an advantageous embodiment, at least one appropriate web guide device is provided as a replacement for a respective spreader roll.

If the relevant guide element is provided as a rotatably mounted roll, then the result is, moreover, good emergency running properties since, even in the event of a failure of the pressurized supply, it is not possible for friction to occur between the material web or a moving belt, for example a fabric belt, and the rotating roll.

In the case of a multilayer construction of the guide surface, the pressure loss of the layers can increase from inside to outside. The porosity can decrease from inside to outside. The hole spacing can decrease from inside to outside. In addition, the hole diameter can decrease from inside to outside.

Amongst others, for example, various coating units are also conceivable as the applicator unit.

In order to be able to guide the material web reliably and without creases, it is advantageous to arrange at least one web guide device immediately before, preferably also immediately after, a non-contact drying section.

The non-contact drying sections are generally designed as infrared and/or convection dryers. The non-contact drying is necessary in particular in the case of coated or very moist material webs.

The guide elements of the web guide cleaning form only a relatively thin air pad with the material web, which minimizes the risk of creasing. In addition, the guide elements need relatively little compressed air.

The guide elements of the web guide device can also be assigned non-contact drying apparatuses in order to intensify the drying of the material web. These drying apparatuses are located opposite the guide elements.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a schematic cross-sectional illustration of a guide element used for non-contact web guidance, having a guide surface at least to some extent consisting of porous material,

FIG. 2 shows a schematic cross-sectional illustration of a further embodiment of a guide element which, for example, is designed in the form of a segment of a curve,

FIG. 3 shows a schematic longitudinal sectional illustration of a further embodiment of the guide element, which is subdivided into at least two zones or segments in the transverse direction, the various segments being acted on with the same pressure in the present case,

FIG. 4 shows an embodiment of the guide element which is comparable with the embodiment according to FIG. 3, but with the various segments being acted on with different pressure in the present case,

FIG. 5 shows a schematic illustration of a guide element curved in the transverse direction, which can be used for example for spreading,

FIG. 6 shows a schematic illustration of a preferred embodiment in which a guide element is provided after an applicator unit as a replacement for an air turn, and

FIG. 7 shows a schematic illustration of a non-contact drying section with a guide element.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

FIG. 1 shows, in a schematic illustration, a first embodiment of a guide element 10 used for non-contact web guidance and belonging to a web guide device which, in particular, can be used in a machine used for the production and/or treatment of a material web, in particular paper or board web. In this case, such a guide element 10, as described once more in further detail below, for example, can be used in particular after an applicator unit 34 as a replacement for an air turn (cf. in particular, FIG. 6).

The guide element 10, designed in the form of a roll, for example, in the present case, has a guide surface 12 which consists of an air-permeable porous material 14, to which compressed air can be applied from the inside, in order to form an air pad 18 via the air 16 flowing through the porous material 14 and the moving material web.

The guide element 10 comprises at least one pressure chamber 20, via which compressed air can be applied to the porous material 14.

As illustrated, the guide element 10 can comprise, for example, a carrier 24 containing the pressure chamber 20 and provided with at least one and preferably a plurality of air passage openings 22 and to which the porous material 14 is applied. In the present case, this carrier 24, which is shaped like a roll here, for example, is surrounded completely by porous material 14 in the circumferential direction. However, the wall of the pressure chamber 20 is provided with air passage openings 22 only over part of its circumference, so that the air pad 18 is produced only over part of the circumference of the guide element 10. The air pad 18 is expediently produced at least in the region in which the material web wraps around the guide element 10.

Because of the roll-like design, the guide element 10 has a radius of curvature in the machine running direction L, in particular also in the wrap region.

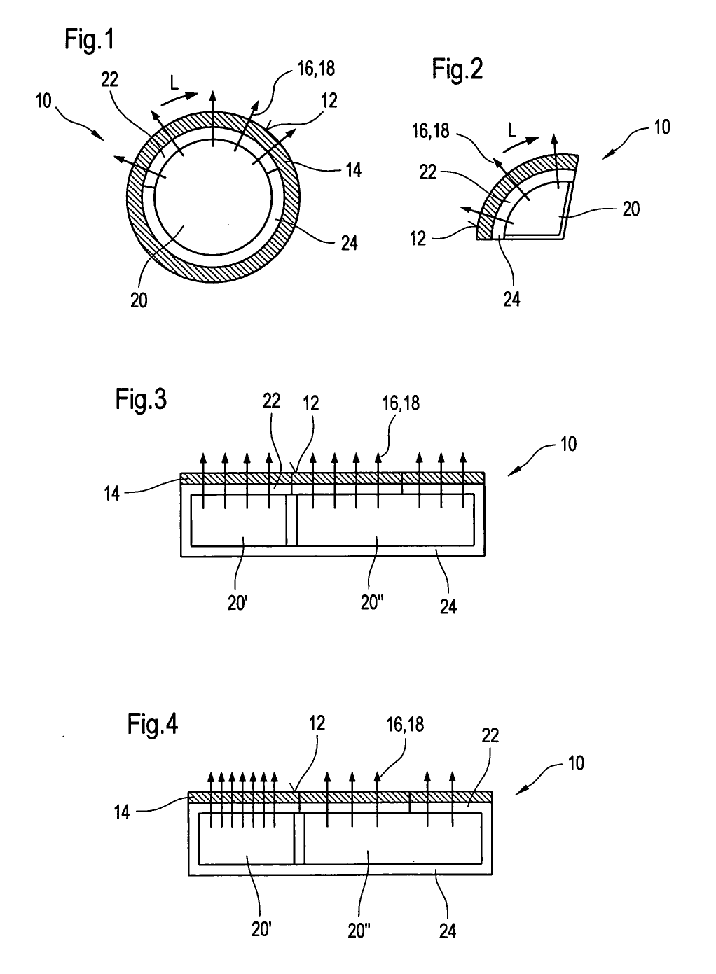

FIG. 2 shows, in a schematic cross-sectional illustration, a further embodiment of the guide element 10, which here is designed in the form of a segment of a curve, for example. The relevant segment again has compressed air applied to it via a pressure chamber 20, so that air 16 flows through the porous material 14 from inside to outside. In the present case, too, the porous material 14 is again applied to the outside of a carrier 24 containing the pressure chamber 20. The wall of the carrier 24 or the pressure chamber 20 is again provided with air passage openings 22, via which compressed air is applied to the porous material 14 from inside.

As can be seen from FIG. 2, in the present case the guide element 10 or its guide surface 12 is again also curved in the machine running direction L. Just as in the embodiment according to FIG. 1, here, too, the radius of curvature is for example constant over the wrap region.

FIG. 3 shows a further embodiment of the guide element 10 in a schematic longitudinal sectional illustration. In this case, the guide element 10 or its pressure chamber is subdivided in the transverse direction into at least two zones or segments 20′, 20″, via which the porous material 14 can be acted on with compressed air separately in the transverse direction, if appropriate. In the phase reproduced in FIG. 3, the zones 20′, 20″ have the same pressure applied to them at least for some time. In contrast, FIG. 4 shows the same guide element 10 in a phase in which the zones or segments 20′, 20″ are currently having different pressures applied to them.

The pressure can therefore be varied over the width, that is to say in the transverse direction, in the desired manner, depending on the respective requirements.

Otherwise, the guide element 10 can, at least substantially, in particular again have a structure such as has been described in connection with the other embodiments. Mutually corresponding parts are assigned the same designations.

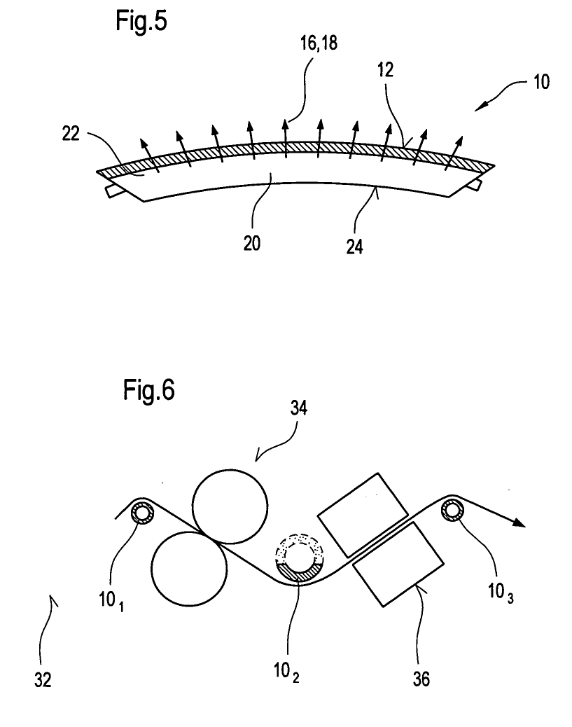

FIG. 5 shows a guide element 10 in a schematic illustration in the transverse direction, which may be used for example for spreading. The guide element again has a carrier 24 with at least one pressure chamber 20, to which the porous material 14 is applied, and via whose pressure chamber 20 the porous material 14 is acted on from the inside with compressed air.

The effective deflection radius can for example be changed with corresponding rotation of the guide element 10.

Incidentally, this embodiment may again at least substantially have the same structure as the embodiments described previously. Sections which correspond to one another have been assigned the same reference symbols.

Whereas, in the exemplary embodiments described previously, the porous material 14 is in each case applied to a carrier 24 provided with air passage openings 22, in principle at least a part of a carrier wall or at least a part of the wall of the pressure chamber 20 can also be formed by the porous material 14.

In the illustration according to FIG. 6, a guide element 10₁ is arranged after the drying section 32 and before an applicator unit 34, a guide element 10₂ is arranged as a replacement for an air turn between the applicator unit 34 and, for example, an impingement dryer 36, and a guide element 10₃ is arranged after the impingement dryer 36. The guide elements 10 can in particular again be designed in such a way as has been described previously, for example by using FIGS. 1 to 5.

It is also possible, for example, for at least one guide element 10 to be provided in a coating machine, before a rewind and/or after an unwind.

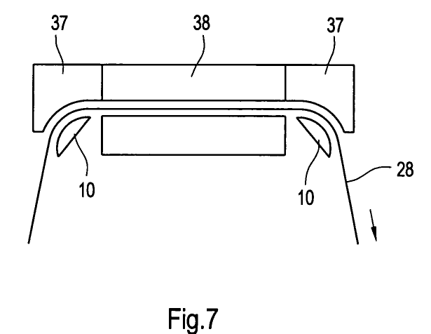

In the embodiment according to FIG. 7, the material web 28 runs through a non-contact drying section 38 in which hot air is blown on to both sides of the material web 28.

In order in this case to be able to guide the material web 28 securely and without the risk of creasing immediately before and after this drying section, a guide element 10 is in each case located at the start and at the end of the drying section 38. In order to intensify the drying, the material web 28 additionally has hot air blown from drying apparatuses 37 arranged opposite the guide elements 10.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A web guide device comprising at least one guide element arranged after an applicator unit and serving as an air turn for non-contact web guidance in a machine used for at least one of production and treatment of a material web, wherein the at least one guide element has a guide surface that comprises of air-permeable porous material to which compressed air can be applied, in order to form an air pad between the guide surface and the moving material web via the air flowing through this porous material.

2. The web guide device as claimed in claim 1, wherein the guide element comprises at least one pressure chamber, via which the porous material can have compressed air applied to it.

3. The web guide device as claimed in claim 2, wherein the porous material can be applied, at least to some extent, to a carrier containing the pressure chamber and provided with air passage openings.

4. The web guide device as claimed in claim 2 or 3, characterized in that the porous material (14) forms at least part of the pressure chamber wall.

5. The web guide device as claimed in claim 2, wherein the pressure in the pressure chamber is higher than 0.5 bar.

6. The web guide device as claimed in claim 1, wherein the specific volume flow in the porous material lies in a range from about 10 to about 5000 Nm³/h·m².

7. The web guide device as claimed in claim 1, wherein the air-permeable porous material has outlet openings, wherein one of a hole, pore spacing and spacing of the outlet openings of the air-permeable porous material is less than 1 mm.

8. The web guide device as claimed in claim 1, wherein the air-permeable porous material has at least one of outlet openings, holes and pores, and wherein the average size of one of the outlet openings, pores and holes in the porous material is less than 0.2 mm.

9. The web guide device as claimed in wherein pressure loss from the side facing away from the moving material web to the side of the porous material facing the material web is greater than 0.2 bar.

10. The web guide device as claimed in claim 1, wherein the thickness of the air pad formed between the guide surface and the moving material web is less than 5 mm.

11. The web guide device as claimed in claim 1, wherein the guide element is designed as a roll.

12. The web guide device as claimed in claim 11, wherein the guide element is one of a stationary and nonrotating roll.

13. The web guide device as claimed in claim 11, wherein the air pad is produced on only part of the circumference of the roll.

14. The web guide device as claimed in claim 11, wherein the guide element is a rotating roll.

15. The web guide device as claimed in claim 11, wherein the roll has a diameter in a range from about 50 mm to about 1500 mm.

16. The web guide device as claimed in claim 1, wherein the guide element is wrapped around only by the material web.

17. The web guide device as claimed in claim 16, wherein the guide element is also wrapped around by at least one moving belt, in particular a fabric belt, in addition to the material web.

18. The web guide device as claimed in claim 17, wherein the moving belt is guided between the guide element and the material web.

19. The web guide device as claimed in claim 17, wherein the moving belt is guided on the side of the material web facing away from the guide element.

20. The web guide device as claimed in claim 17, wherein at least one of the material web and the moving belt wraps around the guide element in accordance with a wrap angle whose range is from about 5 to about 260°.

21. The web guide device as claimed in claim 1, wherein the guide element is designed as a segment of a curve.

22. The web guide device as claimed in claim 21, wherein the guide element has a radius of curvature which is constant in the machine running direction (L).

23. The web guide device as claimed in claim 21, wherein the guide element has a radius of curvature which changes in the machine running direction (L).

24. The web guide device as claimed in claim 22, wherein the guide element has a radius of curvature which changes continuously in the machine running direction (L).

25. The web guide device as claimed in claim 22, wherein the guide element has a radius of curvature which changes in discrete steps in the machine running direction (L).

26. The web guide device as claimed in claim 21, wherein at least one of the guide element and a guide surface of the guide element has a course which is curved in the transverse direction.

27. The web guide device as claimed in claim 26, wherein the radius of curvature of one of the guide element and the guide surface changes over the width extending in the transverse direction.

28. The web guide device as claimed in claim 21, wherein the guide element designed as a segment of a curve has a segment height in a range from about 30 to about 500 mm.

29. The web guide device as claimed in claim 21, wherein a radius of curvature of the guide surface lies in a range from about 5 to about 3000 mm.

30. The web guide device as claimed in claim 1, wherein the guide element is assembled from a plurality of individual segments in one of a transverse direction and a machine running direction (L).

31. The web guide device as claimed in claim 30, wherein at least some of the segments are assigned a common compressed air supply.

32. The web guide device as claimed in claim 30, wherein the segments are at least to some extent assigned separate compressed air supplies.

33. The web guide device as claimed in claim 30, wherein an application of compressed air which is separated zone by zone via at least one of individual separate segments and segment groups in at least one of a machine running direction (L) and in a transverse direction is provided.

34. The web guide device as claimed in claim 1, wherein the guide surface of the guide element is formed by at least two layers in each case comprising air-permeable porous material with at least one of the same properties and different properties.

35. The web guide device as claimed in claim 34, wherein pressure loss in an inner layer, facing away from the material web, is lower than on an outer layer.

36. The web guide device as claimed in claim 34, wherein at least one of the porosity of the inner layer, facing away from the material web is higher than the outer layer and its hole spacing is greater than in the outer layer.

37. The web guide device as claimed in claim 36, wherein the hole diameter of the inner layer, facing away from the material web, is greater than in the outer layer.

38. The web guide device as claimed in claim 34, wherein the layers consist, at least to some extent, of different material.

39. The web guide device as claimed in claim 1, wherein the inner layer, facing away from the material web, further comprises at least one of an air-permeable porous material and air passage openings only in a subregion and is otherwise air-impermeable, so that an air pad is produced only in the subregion of the guide element.

40. The web guide device as claimed in claim 1, wherein the inner layer, facing away from the material web comprises at least one of metal, GRP and CRP.

41. The web guide device as claimed in claim 1, wherein the inner layer, facing away from the material web, supplies the mechanical loadbearing capacity of at least one of the guide element and the guide surface.

42. The web guide device as claimed in claim 1, wherein an outermost surface of the guide element, facing the material web, comprises finely porous material.

43. The web guide device as claimed in claim 1, wherein an outermost surface of the guide element facing the material web, is sintered.

44. The web guide device as claimed in claim 1, wherein an outermost surface of the guide element, facing the material web, consists of ceramic material.

45. The web guide device as claimed in claim 1, wherein an outermost surface of the guide element, facing the material web, comprises a material which can be cleaned easily.

46. The web guide device as claimed in claim 1, wherein the guide surface of the guide element has air outlet openings.

47. A machine for at least one the production and treatment of a material web comprising at least one web guide device as claimed in claim 1.

48. The machine as claimed in claim 47, wherein at least one appropriate web guide device is provided immediately after an applicator unit.

49. The machine as claimed in claim 48, wherein the guide element is wrapped around only by the material web.

50. The machine as claimed in claim 48, wherein the guide element is wrapped around by at least one fabric belt in addition to the material web.

51. The machine as claimed in claim 47, wherein at least one appropriate web guide device is provided as a replacement for a respective spreader roll.

52. The machine as claimed in claim 47, wherein at least one web guide device is arranged immediately before a non-contact drying section.

53. The machine as claimed in claim 47, wherein at least one web guide device is arranged immediately after a non-contact drying section.

54. The machine as claimed in claim 52, wherein the non-contact drying section is at least one of an infrared dryer and a convection dryer.

55. The machine as claimed in claim 47, wherein the material web is assigned a non-contact drying apparatus.

56. The web guide device as claimed in claim 2, wherein the pressure in the pressure chamber is higher than 1 bar.

57. The machine as claimed in claim 53 wherein the non-contact drying section is at least one of an infrared dryer and a convection dryer.
